(19) United States
(12) Patent Application Publication
(10) Pub. No.: US 2025/0206166 A1
(43) Pub. Date: Jun. 26, 2025

(54) STATIONARY FLOOR ASSEMBLY FOR AN INDUCTIVE CHARGING DEVICE

(71) Applicant: MAHLE International GmbH, Stuttgart (DE)

(72) Inventors: Thomas Himmer, Reichenbach (DE); Holger Schroth, Maulbronn (DE); Martin Steinbach, Waiblingen (DE)

(21) Appl. No.: 18/852,458

(22) PCT Filed: Jan. 31, 2023
(86) PCT No.: PCT/EP2023/052235

§ 371 Date: Sep. 28, 2024

(30) Foreign Application Priority Data
Mar. 29, 2022 (DE) 10 2022 203 079.6

(51) Int. Cl. B60L 53/302; B60L 53/12; H01F 27/08; H02J 50/00

(52) U.S. Cl. CPC B60L 53/302; B60L 53/12; H01F 27/085; H02J 50/005

(57) ABSTRACT

A stationary underbody assembly for an inductive charging device for inductive charging of a motor vehicle may include a closed housing, at least one flat coil, a core arrangement configured to guide a magnetic flux, at least one support, and a cooling air duct. The housing may include a floor arranged at a spacing distance from a substrate. The flat coil may be arranged in the housing spaced apart from the floor in a spacing direction. The core arrangement may be disposed in the housing between and spaced apart from the floor and the flat coil. The support may be arranged within a central region of a core body of the core arrangement and connect the core arrangement and the floor in a heat-transferring manner. The cooling air duct may extend below the floor. The support may penetrate the floor and support the housing on the substrate.

### CROSS-REFERENCE TO RELATED APPLICATIONS

This application claims priority to International Patent Application No. PCT/EP2023/052235, filed on Jan. 31, 2023, and German Patent Application No. DE 10 2022 203 079.6, filed on Mar. 29, 2022, the contents of both of which are hereby incorporated by reference in their entirety.

### TECHNICAL FIELD

The present invention relates to a stationary underbody assembly for an inductive charging device for inductive charging of a motor vehicle.

### BACKGROUND

In the case of motor vehicles that are at least partially electrically driven, a direct electrical, plug-based connection can be established between the motor vehicle and an external electrical energy source for charging, which however requires a manual activity of a user.

It is also known to charge electrical energy storage unit of the motor vehicle inductively. Corresponding charging units have an assembly (vehicle assembly) in the motor vehicle and a stationary assembly (ground assembly) outside the same. The assembly outside the vehicle contains a primary coil which interacts inductively with a secondary coil of the assembly in the vehicle in order to charge the energy storage unit.

During operation of the charging unit, heat can be generated in the respective assembly, in particular in the stationary underbody assembly, particularly due to the charging power to be provided, which can lead to an undesirable increase in temperature of the underbody assembly and/or neighboring objects and, as a result, to a derating (reduction in charging power due to excessive heat in the system) or failure of the system during charging.

### SUMMARY

The present invention therefore deals with the problem of specifying an improved or at least different embodiment for an underbody assembly for an inductive charging device of the type mentioned at the beginning, which is characterized in particular by the permanent achievement of the rated power in as many operating points as possible (including high outside temperature, high humidity, high current in the system.

According to the invention, this problem is solved by the subject matter of the independent claim(s). Advantageous embodiments are the subject matter of the dependent claim(s).

The present invention is based on the general idea of improving power transmission during charging, in particular of an electric vehicle, by means of a stationary underbody assembly according to the invention having a housing supported on a base with a flat coil arranged therein and a core arrangement likewise arranged therein, in that a cooling air duct runs between the housing and the base, which can be actively ventilated and thereby cools both the core arrangement and the flat coil. The stationary underbody assembly can be driven over by a motor vehicle to be charged. The housing has a base and is arranged at a distance from the floor in a spacing direction. The flat coil, which comprises a conductor, is arranged in the housing and spaced apart from the floor. A core arrangement for guiding a magnetic flux, which comprises at least one core body, which extends in a plate-shaped manner transversely to the spacing direction and comprises a central region and at least one edge region, is likewise arranged spaced apart in the housing and in the direction of distance to the floor, the conductor, and the plane coil. For support, at least one support is provided, which is arranged within the central region of an associated core body and connects the core arrangement and the base in a heat-transferring manner, wherein the at least one support penetrates the base and supports the housing directly or indirectly via a baseplate on the floor. The cooling air duct runs beneath the floor, in particular between the floor and the subsurface, which enables particularly effective cooling of the flat coil or the core arrangement. The particularly effective cooling is achieved on the one hand by the cooling air flowing into the cooling air duct cools at the floor and, by this, a closed interior space of the housing, in which both the flat coil and the core arrangement are arranged. On the other hand, the core arrangement or the flat coil is cooled via the at least one support, which directly or indirectly supports the core arrangement on the substrate and thereby crosses the cooling air duct and is thus also cooled by cooling air flowing in the cooling air duct. The at least one support serves to support the core arrangement or the flat coil as well as a cover plate arranged above it, over which, for example, a motor vehicle can be driven. With the stationary underbody assembly according to the invention, it is possible to operate the latter powerfully, since the particularly effective cooling of both the core arrangement, i.e., the ferrite plates, and the flat coil, is possible via the cooling air duct and the heat-dissipating effect of the supports or the floor.

In an advantageous further advancement of the invention, a baseplate is provided, which extends in a plate-shaped manner transversely to a spacing direction, wherein the at least one support connects the core arrangement and the baseplate in a heat-transmitting manner and wherein the cooling air duct extends between the floor and the baseplate. The flat coil with its conductor is spaced apart from the baseplate in the direction of the distance. The magnetic flux is guided via the core arrangement, whereby the core arrangement is spaced apart from the baseplate and the flat coil and is arranged between the baseplate and the flat coil. The core arrangement and the flat coil are arranged in the closed housing above the baseplate, wherein the housing is closed with respect to the baseplate by the floor. The housing including the core arrangement and the flat coil are now supported on the baseplate by the at least one support that penetrates the floor, and at the same time the core arrangement and the baseplate are connected in a heat-transfer manner. The aforementioned cooling air duct now extends between the floor and the baseplate, which enables the effective cooling of the flat coil or the core arrangement.

In order to further support this effect, it can also be provided that the supports or at least one support are made of a heat-conducting material with a thermal conductivity of λ>5 W/(m·K). In theory, it is even conceivable that the baseplate and/or the base of the housing is also made of a heat-conducting material and also has its own cooling channels and is thus not only cooled by the cooling air flowing in the cooling air duct, but also by a coolant flowing in the cooling channels. The at least one support is thus assigned two tasks, namely, on the one hand, the support of the core arrangement or the flat coil arranged thereon and, on the other hand, the cooling of these components by connecting the flat coil or the core arrangement and its core body to the cooling air duct or the baseplate in a heat-transfer manner. If the core arrangement thus heats up during operation of the stationary underbody assembly according to the invention, heat can be dissipated via the at least one support into the cooling channel or into the baseplate, which is designed in particular as a cooling plate, whereby uniform cooling of the core arrangement and the flat coil is made possible with several such supports, whereby the same charging power can be achieved with a smaller cross-section of the conductor of the flat coil or a higher charging power can again be achieved with the same cross-section of the conductor of the flat coil. By arranging the respective support in accordance with the invention at a distance below the middle area of the associated core body, the support can also be positioned in relation to the associated core body in an area in which the magnetic flux density is sufficiently low so that eddy current losses or hysteresis losses cannot occur there or at least only to a negligible extent when metallic materials are used for the support. This also prevents field distortion and thus a different operating behavior of the coil system as well as additional heating of the metallic material indirectly by the magnetic field. Such a middle area in the flat coil designed as a primary coil in the stationary underbody assembly is, for example, explicitly arranged in the middle of the associated ferrite plate or the associated core body, wherein a distance to the edge of the core body, for example the ferrite plate, can differ depending on the orientation of the primary expected direction of the magnetic field. This means that the edge area of each core body, for example each ferrite plate, are defined individually depending on the shape of the expected magnetic flux direction or magnetic flux density.

In an advantageous further advancement of the stationary underbody assembly according to the invention, the at least one support comprises a cavity and is configured such that a cooling air flowing into the cooling air duct is directed in the direction of the core body. The cavity thus serves as an air cooling duct and allows for an effective cooling of the core arrangement and the flat coil.

In an advantageous further advancement of the stationary underbody assembly according to the invention, a deflection element is arranged on the baseplate, which engages in the cavity of the support. This deflection element is used to deflect the cooling air flowing in the cooling air duct and to guide it up and then down in a chimney-like manner inside the support. This makes it possible to cool the at least one support evenly over the entire height, whereby it can unfold its cooling effect not only in a connecting area with the associated core body, but also in the enclosed interior space of the housing, which is closed off from the baseplate by the floor, and in which both the core arrangement and the at least one flat coil are located. This allows for a particularly effective cooling and thus a powerful operation of the stationary underbody assembly according to the invention.

In an advantageous further advancement, the floor and/or the baseplate has at least one cooling channel for a coolant. This enables active cooling of the floor of the housing and/or of the baseplate during operation, wherein the heat-conducting supports also cool the core arrangement or the core body and the flat coil arranged above it in the installed state. In addition, the actively cooled baseplate or the actively cooled floor in turn cools the cooling air flowing in the cooling air duct.

The floor and/or the baseplate itself is advantageously made of a metal or metal alloy, such as aluminum, to improve heat transfer between the coolant, cooling air, and the baseplate, air, and supports. The spaced arrangement of the floor and/or the baseplate relative to the flat coil and the core arrangement also minimizes or at least reduces an electromagnetic interaction between the floor or rather the baseplate and the flat coil and the core arrangement. The distance between the floor and/or the baseplate and the core arrangement in the spacing direction can be between a few millimeters and several centimeters. By manufacturing the floor and/or the baseplate from metal or a metal alloy, the underbody assembly is also a magnetically or rather electromagnetically shielded from the stationary underbody assembly.

In an advantageous further advancement of the solution according to the invention, the at least one support is at least partially made of metal, in particular aluminum. Alternatively, it is also conceivable that the at least one support is partially made of graphite or ceramic, in particular aluminum nitride or aluminum silicide. Graphite has a thermal conductivity λ of 15 to 20 W/(m K), while an aluminum nitride ceramic can even have a conductivity λ of 180 W/(m K). The use of such aluminum nitride ceramics in particular is of great interest where a lot of heat has to be dissipated; however, where a material may not be electrically conductive under certain circumstances.

A fan is conveniently provided to supply cooling air in the cooling air duct. A cooling air flow in the cooling air duct can be forced by such a fan, whereby an active and thus particularly effective cooling of the stationary underbody assembly according to the invention can be achieved. Such a fan can be an internal fan, wherein such a fan can of course also comprise an external fan.

In a further advantageous embodiment of the stationary underbody assembly according to the invention, heat transfer elements are arranged on the floor and/or the baseplate, which project into the cooling air duct. Such heat transfer elements can be designed as cooling fins or cooling rods, for example, and can provide a larger surface area available for heat transfer, which in particular allows heat dissipation on the floor and/or the baseplate and, via this/these also provides heat dissipation of the supports connected to the floor and/or the baseplate. Of course, it is also theoretically conceivable that the individual supports have additional heat exchanger elements that increase the surface area of the supports, at least in the cooling air duct, but also in the housing, and thus improve heat transfer.

A distributor plate (heat spreader) is conveniently arranged between the at least one support and the core arrangement or the retaining structure. Such a distributor plate can ensure improved heat transfer and thus improved cooling of the core arrangement, wherein it is of course clear that the distributor plate, if it is metallic, is also arranged within the middle area, in particular in order to at least minimize any influence on the magnetic field and thus the generation of eddy current losses.

In a particularly advantageous embodiment of the stationary underbody assembly according to the invention, the distribution plate is connected to the core arrangement via an adhesive layer with a thermal conductivity of λ>0.8 W/(mK) and/or a shear modulus of G<10 MPa. As the adhesive layer, for example an adhesive layer, is extremely thin, a reduced thermal conductivity λ of λ>0.8 W/(m K) is also sufficient here. In order to also be able to compensate for different thermal expansion coefficients between the core bodies, for example a ferrite plate, and the distributor plate, it is advantageous to provide the adhesive layer or the adhesive layer in general with a shear modulus G<10 MPa.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

They show, each schematically,

FIG. 1—shows a sectional view of a stationary underbody assembly according to the invention,

FIG. 2—shows a further sectional representation through the underbody assembly in different sectional planes,

FIG. 3—shows an illustration as in FIG. 2; however, with different sectional planes,

FIG. 4—shows a sectional view through a further embodiment of the underbody assembly according to the invention.

### DETAILED DESCRIPTION

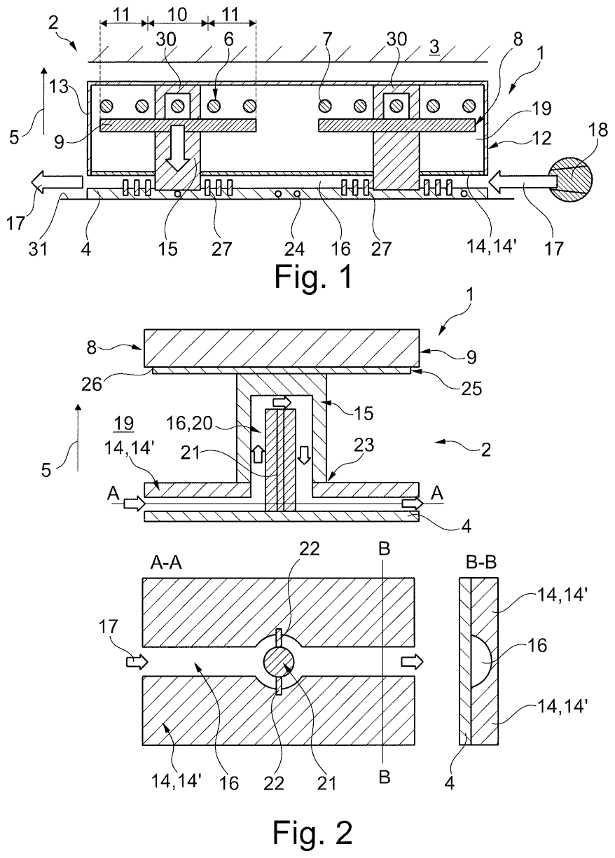

According to FIGS. 1 to 4, a stationary underbody assembly 1 according to the invention for an inductive charging device 2 for inductive charging, for example of a motor vehicle 3, comprises a closed housing 12 with a floor 14, wherein the housing 12 is arranged at a distance from a substrate 31 in a spacing direction 5. In addition, the underbody assembly 1 comprises at least one flat coil 6 with a conductor 7 arranged in the housing 12 and spaced apart from the floor 14 in the spacing direction 5. Furthermore, a core arrangement 8 is provided for guiding a magnetic flux, which is arranged in the interior of the housing 12 in the spacing direction 5 from the floor 14 and the flat coil 6 and between the floor 14 and the conductor 7 and has at least one core body 9 which extends in a plate-like manner transversely to the spacing direction 5 and has a central region 10 and at least one edge region 11. For direct or indirect support relative to the substrate 31, at least one support 15 is provided, which is arranged within the central area 10 of an associated core body 9 and connects the core arrangement 8 and the floor 14 in a heat-transferring manner. The at least one support 15 penetrates the floor 14, wherein a cooling air channel 16 runs between the floor 14 and the substrate 31 (cf. FIG. 1 to 3) or between the floor 14 and the base plate 4 (cf. FIG. 4). The baseplate 4 rests at least partially against the substrate 31.

The housing 12 has a housing upper part 13 that is tightly connected to the floor 14, wherein the floor 14 can be designed as a plastic floor 14′ or as a metal floor 14”. During operation of the stationary underbody assembly 1 according to the invention, the cooling air duct 16 is flowed through for cooling said underbody assembly, for example by cooling air 17, in particular driven by a fan 18.

Above the core arrangement 8 or the respective core body 9, one support element 30 each is arranged, which supports the upper part of the housing 13. A support plate (not shown) can be arranged above the upper housing part 13, whereby it is theoretically also conceivable that the upper housing part 13 can be directly driven over by a motor vehicle 3. The stationary underbody assembly 1 is arranged in or on the substrate 31 and can be driven over, for example, by a motor vehicle 3 to be charged.

With the stationary underbody assembly 1 according to the invention, it is thus possible enable effective cooling and thus powerful operation of the same, wherein the support of the core arrangement 8 in the central area 10 of the respective core body 9 also results in an arrangement of the supports 15 in one area, in which the magnetic flux density generated by the flat coil 6 is minimal, and thus a hindrance of the magnetic field or magnetic flux density is not feared or only marginally feared. This offers the great advantage that even a metallic material can be used for the supports 15, which is not only load-bearing but also has favorable thermal conductivity, without causing eddy currents or hysteresis losses in the respective support 15. In the stationary underbody assembly 1 according to the invention, heat dissipation and thus cooling of the flat coils 6 or the core bodies 9 is not only possible via the heat-conducting supports 15, but generally also via an arrangement of both the core bodies 9 and the flat coils 6 in a closed interior space 19, which is connected to the cooling air duct 16 via the floor 14 in a heat-transferring manner.

As shown in FIG. 2, the at least one support 15 can also have a cavity 20, whereby a comparatively large area available for heat transfer is provided in the interior of the support 15, which can be used both for direct cooling of the associated core body 9 and for cooling the closed interior space 19.

According to FIG. 2, a deflection element 21 can be arranged on the baseplate 4, which engages in the cavity 20 and deflects the cooling air 17. According to the sectional view A-A in FIG. 2, the deflection element 21 has a round cross-section with lateral wings 22 integrated into the floor 14 or the plastic floor 14′. The cooling air duct 16 has a semicircular cross-section according to the sectional view B-B. In such a configuration, the cavity 20 arranged in the support 15 and divided by the deflection element 21 is part of the cooling air channel 16, which thus improves the heat transfer from the flat coil 6 and the core body 9 to the cooling air 17. The floor 14 is connected to the support 15 via a waterproof bond 23. It is thereby possible to achieve a complete sealing of the interior space 19.

The at least one support 15 can be formed at least partially from metal, for example aluminum, and/or preferably have a thermal conductivity λ of λ>5 W/(m·K). This allows for an effective heat dissipation of the core bodies 9 and the flat coils 6.

To convey the cooling air 17 in the cooling air duct 16, the previously mentioned fan 18 can be provided, which is coupled to the environment and/or to an additional cooling device (not shown), for example a heat exchanger. Furthermore, by adjusting the power of the fan 18, the cooling power and thus indirectly also a possible retrievable charging power of the stationary underbody assembly 1 according to the invention can be controlled or regulated.

The floor 14 or the baseplate 4 can also be made of aluminum and additionally comprise cooling channels 24, into which a coolant can be guided for additional cooling. This enables a further increase in the cooling effect and thus a further possible increase in the charging capacity of the stationary underbody assembly 1.

Furthermore, a distributor plate 25 can be arranged between the at least one support 15 and the core arrangement 8, which contributes to improved heat transfer and thus improved cooling of the core arrangement 8. It is of course clear that the distributor plate 25 is also preferably arranged within the central area 10, in order to at least minimize any influence on the magnetic field and thus the generation of eddy current losses, particularly when the distributor plate 25 is made of a metallic material. The distributor plate 25 can also be bonded to the core arrangement 8 via an adhesive layer with a thermal conductivity of λ>0.8 W/(m·K) and/or a shear modulus of G<10 MPa. As the adhesive layer 26, for example an adhesive layer, which is extremely thin, it is sufficient to have a reduced thermal conductivity λ of λ>0.8 W/(m·K). Furthermore, in order to be able to compensate for different thermal expansion coefficients between the core bodies 9, for example a ferrite plate and the distributor plate 25, it is advantageous to provide the adhesive layer or generally the adhesive layer 26 with a shear modulus G<10 MPa.

Looking again at FIG. 1 in particular, it can be seen that heat transfer elements 27 are arranged on the baseplate 4, which protrude into the cooling air duct 16 and again enlarge an area available for heat transfer. According to FIG. 4, heat transfer elements 27, which project into the cooling air duct 16, can also be arranged on the floor 14 in an analogous manner.

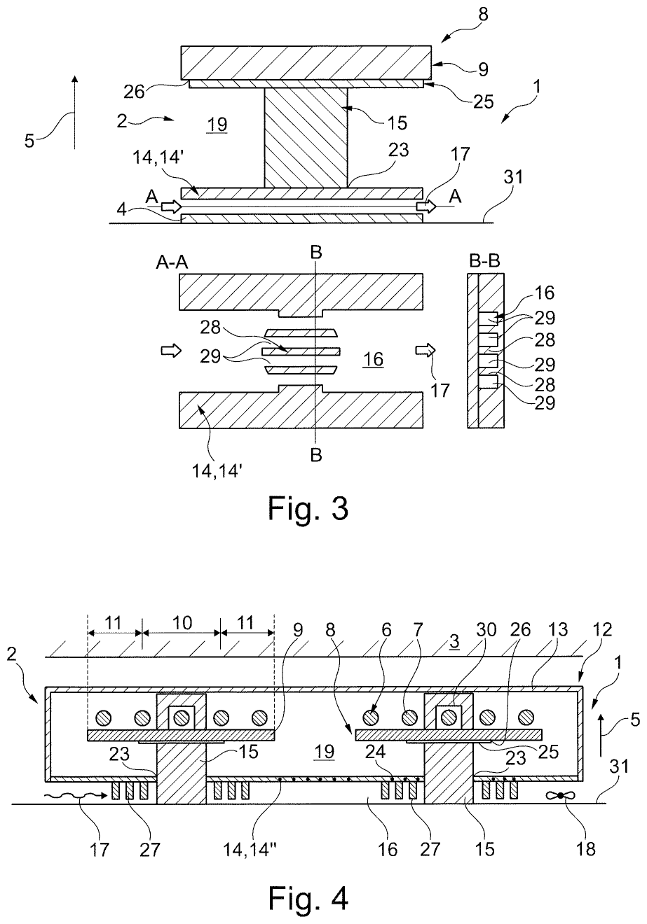

Looking at FIG. 3, it can be seen that floor 14, or rather the plastic floor 14′, has individual webs 28 in the area below the support 15, which divide the continuous cooling air duct 16 located below the support 15 into individual duct sections 29. This allows the support 15 to be supported on the baseplate 4 without any problems. As an alternative embodiment (not shown here), it is also conceivable that instead of the webs 28, a number of individual rods, e.g. with a cylindrical cross-section, are arranged in a staggered arrangement known to the expert, which promotes heat transfer and offers little resistance to the air flow.

With the stationary underbody assembly 1 according to the invention, it is thus possible to achieve particularly effective cooling of the core arrangement 8 or the flat coil 6 via the hollow supports 15 designed as air shafts, whereby they can transmit a higher charging power. Due to the arrangement of the supports 15 essentially in the central area 10 of the respective core arrangements 8 and a heat-conducting design of the supports 15, these can also contribute to the heat dissipation and thus cooling of the associated flat coil 6 with its conductor 7 or the core arrangement 8 with the respective associated core body 9, for example a ferrite plate, without having to fear impairment due to hysteresis effects or eddy current losses. The cooling air 17 flowing in the cooling air duct 16 can be adjusted in terms of its flow velocity by means of the fan 18 according to a desired cooling performance and/or can be supported by means of additional cooling of the baseplate 4 via coolant flowing therein in cooling ducts 24.

1. A stationary underbody assembly for an inductive charging device for inductive charging of a motor vehicle, comprising:
a closed housing including a floor arranged at a spacing distance from a substrate;
at least one flat coil arranged in the housing spaced apart from the floor in a spacing direction, the at least one flat coil including a conductor;
a core arrangement configured to guide a magnetic flux, the core arrangement disposed in an interior of the housing spaced apart in the spacing direction from the floor and the at least one flat coil, the core arrangement arranged between the floor and the conductor, the core arrangement including at least one core body extending in a plate-shaped manner transversely to the spacing direction, the at least one core body having a central region and at least one edge region at least one support arranged within the central region of the at least one core body and connecting the core arrangement and the floor in a heat-transferring manner; and
a cooling air duct extending below the floor;
wherein the at least one support penetrates the floor and supports the housing on the substrate.

2. The floor assembly according to claim 1, further comprising a baseplate extending in a plate-shaped manner transversely to the spacing direction, wherein:
the at least one support is arranged on the baseplate and connects the core arrangement and the baseplate in a heat-transferring manner; and
the cooling air duct extends between the floor and the baseplate.

3. The floor assembly according to claim 2, wherein the at least one support includes a cavity via which a cooling air flowing in the cooling air duct is guidable to the at least one core body.

4. The floor assembly according to claim 3, further comprising a deflecting element arranged on the baseplate and protruding into the cavity.

5. The floor assembly according to claim 1, wherein the at least one support is at least partially composed of metal.

6. The floor assembly according to claim 1, further comprising a fan structured and arranged to convey cooling air through the cooling air duct.

7. The floor assembly according to claim 1, wherein the floor includes at least one cooling channel through which a coolant is flowable.

8. The floor assembly according to claim 2, wherein the baseplate includes at least one cooling channel through which a coolant is flowable.

9. The floor assembly according to claim 2, wherein the baseplate is at least partially composed of aluminum.

10. The floor assembly according to claim 1, further comprising a distributor plate arranged between the at least one support and the core arrangement.

11. The floor assembly according to claim 10, wherein the distributor plate is connected to the core arrangement via an adhesive layer.

12. The floor assembly according to claim 11, wherein the adhesive layer has a thermal conductivity of at least 0.8 W/(m·K).

13. The floor assembly according to claim 1, further comprising a plurality of heat transfer elements arranged on the floor and projecting into the cooling air duct.

14. The floor assembly according to claim 2, further comprising a plurality of heat transfer elements arranged on the baseplate and projecting into the cooling air duct.

15. The floor assembly according to claim 1, wherein the floor is one of a plastic floor and a metal floor.

16. The floor assembly according to claim 1, wherein the cooling air duct extends between the floor and the substrate.

17. The floor assembly according to claim 1, wherein the at least one support is at least partially composed of aluminum.

18. The floor assembly according to claim 1, wherein the at least one support includes a cavity via which a cooling air flowing in the cooling air duct is guidable to the at least one core body.

19. The floor assembly according to claim 11, wherein the adhesive layer has a shear modulus of 10 MPa or less.

20. A stationary underbody assembly for an inductive charging device for inductive charging of a motor vehicle, comprising:
a closed housing including a floor oriented transversely to a spacing direction;
at least one flat coil arranged in the housing and disposed spaced apart from the floor in the spacing direction, the at least one flat coil including a conductor;
a core arrangement configured to guide a magnetic flux, the core arrangement disposed in the housing spaced apart from the floor and from the at least one flat coil in the spacing direction, the core arrangement arranged between the floor and the conductor, the core arrangement including a plurality of plate-shaped core bodies oriented transversely to the spacing direction;
a cooling air duct through which a cooling air is flowable, the cooling air duct disposed outside of the housing and extending along the floor such that an interior space of the housing and the cooling air duct are connected in a heat-transferring manner via the floor; and
a plurality of supports via which the housing is supportable on a substrate, each of the plurality of supports arranged within a central region of a respective core body of the plurality of core bodies, penetrating through the floor, and projecting into the cooling air duct;
wherein the plurality of supports connect the core arrangement and the floor in a heat-transferring manner.
